(19) United States
(12) Patent Application Publication
(10) Pub. No.: US 2009/0046254 A1
(43) Pub. Date: Feb. 19, 2009

(54) PROJECTOR SYSTEM

(75) Inventors: Adrianus Johannes Stephanus Maria De Vaan, Eindhoven (NL); Holger Moench, Vaals (NL); Gero Heusler, Aachen (DE); Ad Van Den Brandt, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/577,372

(22) PCT Filed: Oct. 18, 2005
(86) PCT No.: PCT/IB05/53412

§ 371 Date: Apr. 17, 2007

(30) Foreign Application Priority Data
Oct. 22, 2004 (EP) 04105237.4

(51) Int. Cl. G03B 21/26

(52) U.S. Cl. 353/30

(57) ABSTRACT

An laser based image projection system for displaying images, which comprises an LCD device and projection optics. By introducing a diffuser between the LCD device and the projection optics, the quality of the projected image is improved. The visibility of material imperfections in the optical the beam path, which were previously visible in the projected image due to the large field-of-depth of the system, is now reduced.

### TECHNICAL FIELD

The present invention generally relates to an image projection system for displaying images, and more specifically to an image projection system comprising a laser based illumination source.

### TECHNICAL BACKGROUND

Projectors can be used in both rear and front image projection systems. In a rear projection system, the projector projects an image representing television or datagraphic information on the rear side of a diffusing transparent screen, which front side is directed to a viewing audience. In a front projection system, the projector projects an image representing television or datagraphic information on the front side of a reflecting screen, which front side is directed to a viewing audience.

In order to meet commercial demands for projectors, there is a constant aim to produce such systems, which are smaller, have a longer life time and project brighter pictures with better contrast.

Below is given a basic description of a conventional front LCD projector, comprising a lamp as an illumination source. Besides LCD devices, other spatial light modulators (SLMs) such as e.g. Micro-mirror Devices (DMDs) can be used to modulate the light with image information.

In the projector there is a light source and a light collection system, consisting of a parabolic reflector and lens plates, to direct the light in the desired direction. The light source is typically an UHP lamp. Further, there is a series of integrators and lenses to shape the beam in the right dimensions and geometry, and to obtain a uniform distribution of the light intensity over the cross-section of the beam. The projector also includes pre-polarization optics such as a polarization conversion system (PCS) consisting for example of a flat multi polarizing beam splitter. The PCS is largely able to convert unpolarized light into polarized light. As in most transmissive front projectors, the white light is thereafter split into the primary colors red, green and blue, by means of color splitting optics or dichroic mirrors. The three different colored light beams are sent through three different lightvalves. Each lightvalve includes a polarizer, an LCD panel and an analyzer. The light valve can either transmit or block the light, i.e. either be arranged in its dark state or bright state. By changing the orientation of the LC molecules in the LCD panel, which can be accomplished by changing the electrical field over the LC layer, it is possible to switch between the bright state and the dark state. The three different colors are thereafter recombined in a single full color image by means of a dichroic cube or similar, and finally the image is projected by means of imaging projection optics.

Recently there has been a desire to replace the arc lamp with a set of lasers. In doing so one needs to solve a number of difficulties in order to obtain a good picture performance and simultaneously obtain a cost efficient and small projection system. Three examples of such problems are i) speckle, laser light is coherent light and as such causing disturbing speckle and interference pattern; ii) large focal depth, which makes faults in the optical visible in the image; iii) the question of how to miniaturize the system without loosing illumination light.

### DESCRIPTION OF THE INVENTION

An object of the present invention is to provide an improved optical arrangement for use in an image projection system with a low etendue illumination system, particular a laser based projection system.

In this description a low etendue illumination system is a system having a confined and narrow beam emitted from a light source or a light source system, such as a laser based light source.

A small etendue causes a large field of depth in the optical system. Thus, imperfections in the optical path such as dust particles, scratches, obscurations, and material defects will be strongly visible in the projected image. Overcoming this by using extremely high quality optical materials is very costly.

The invention is based on an insight that by use of a diffuser arranged on the light outgoing side of an LCD panel in an image projection system, which comprises a laser based illumination source, the quality of the projected image can be improved. Advantageously, the diffuser broadens small and well focused modulated laser beams, such that the projected image is provided with a more homogenous intensity distribution and imperfections in the optical path becomes less visible. In other words, the general idea is to broaden the beam after it has been modulated, but before it passes the projection optics. This gives an easy modulation, as the beam is confined at the modulation, as well as reduces problems related to large field of depth.

Although the invention is described in relation to a projector comprising laser based light sources and an LCD panel, it will be obvious to the man skilled in the art that the invention is also applicable to any other light modulating projection system having a small etendue, and that the diffuser can be any type of light etendue transforming element.

The object of the present invention is achieved by an image projection system, an optical element and a method in accordance with the appended claims 1, 9 and 12. Preferred embodiments are defined in the dependent claims.

According to a first aspect thereof, the present invention provides an image projection system, which comprises a laser light source for providing an illumination beam; a modulation panel for modulating the illumination beam with image information, and projection optics for projecting the modulated illumination beam on a screen. Further, it also comprises etendue transforming means for broadening said modulated illumination beam, wherein said etendue transforming means is arranged after said modulation panel in the light path from the light source to the screen.

According to a second aspect thereof, the present invention provides an optical element for use in an image projection system as described above. The element comprises a substrate provided with a light modulating LCD layer and an etendue transforming layer, wherein said layers are preferably arranged on opposite sides of said substrate.

According to a third aspect thereof, the present invention provides a method of image projection for a projector comprising the sequential steps of: emitting an illumination beam of laser light; modulating the illumination beam with image information; etendue transforming said modulated illumination beam, such that its beam diameter is broadened; and projecting said etendue transformed illumination beam on a screen.

One advantage associated with the three aspects mentioned above is that they provide a better perceived quality of the projected image, due to e.g. that imperfections in the optical system is less visible and that there is a greater homogeneity in the projected image, without the loss of any image information. The imperfections in the projected image are made less visible by a diffusion of the modulated light. The diffuser or etendue transforming element diffusing the light is further arranged such that each pixel in the image is clearly visible.

Advantageously, the etendue transforming element is arranged such that the etendue transformed illumination beam has a substantially uniform far field intensity distribution, or angular distribution. This can be achieved with e.g. a diffractive beam shaper element. In other words, the etendue transformed illumination beam preferably has a top hat like scattering distribution and even more preferably a rectangular angular distribution. This can be achieved with e.g. a beam shaper element. In other words, the projected image can be improved and made more homogenous without the loss of any substantial amount of light. Further, the etendue transforming element is advantageously a holographic diffuser, as these can be tailor made to meet specific demands on optical properties in a cost effective way.

Advantageously, means are introduced such that the visibility of speckle in the projected image is reduced. This can be done by modulating an element in the optical path way faster than the eye response time. This can be done e.g. by vibrating an element faster than about 70 Hz, moving it back and forth across the path of the illumination beam, or rotating it in its plane. This overlays the different speckle patterns and, consequently, possible speckles in the projected image will not be visible for the human eye. Instead, a viewer perceives the image as an average intensity distribution. Preferably, the modulated element is the etendue transforming element.

The visibility of speckles can also be reduced by providing a liquid crystal layer on an etendue transforming element, having a rough diffusing surface. The liquid crystal layer is electro-optically modulated, such that the transmitted light is switched between a diffused and less or not diffused state. Such devices are known in the art. For example, a switchable liquid crystal layer is provided on the rough down stream facing side of a polarization dependent diffuser. The liquid crystal layer can be switched between an active and a passive state by the application or removal of an electric field, which rotates the crystals in the LC material, which rotation affects the refractive index of the liquid crystal material. In the passive state the refractive index of the liquid crystal layer is arranged such that the light is simply transmitted through the switchable layer, without being substantially affected. In the active state, the refractive index of the liquid crystal layer corresponds to that of the etendue transforming element. Hence, the broadening of the light is eliminated or reduced, because the liquid crystal layer is arranged on the rough diffusing layer of the diffuser and has a matching refractive index. The switchable etendue transforming element is preferable combined with an ordinary or non-switchable etendue transforming element, to avoid a high in line transmission in the active state. This electro-optical modulation has the advantage that no moving parts are used.

Advantageously, a micro-lens array is arranged on the light incoming side of the image panel, such that the illumination beam is better focused onto the respective pixels in the image panel. This enables a use of an image panel having smaller pixels, i.e. the center to center distance between two pixels can be made smaller without the loss of any light. In other words, a geometrically smaller image panel can be used.

Some advantages, which are obtained by the embodiments of the invention, have been described above. Similar advantages can also be achieved by corresponding embodiments of said optical element and said method.

The gist of the invention is to expand the beam after is has been modulated, and keep the low etendue (confined) beam for ease of modulation. Expansion of the beam before the projection optics reduces the focal depth and thus makes the system less sensitive to imperfections in the projections optics.

These and other aspects of the invention will be apparent from, and elucidated with reference to, the embodiments described hereinafter.

### BRIEF DESCRIPTION OF THE DRAWINGS

FIG. 1 schematically illustrates a projector according to the invention.

FIG. 2 schematically illustrates an optical component according to the invention.

### DESCRIPTION OF A PREFERRED EMBODIMENT

A description will be given of a preferred embodiment according to the present invention in order to provide a better understanding of the invention. This is facilitated when this description is read in conjunction with the appended drawings. On the drawings like reference characters designate like or corresponding parts through out the schematic figures. The drawings are not drawn to scale.

The illustrated projector system suitably comprises conventional electronic circuitry for operating e.g. the light source and the image panel, which is known in the art and therefore is not described in more detail.

Although the invention is described in relation to a transmissive LCD projector system it is understood that it can also be used in other types of light modulating projectors, e.g. a projector comprising a reflective liquid crystal silicon (LCOS) display panel.

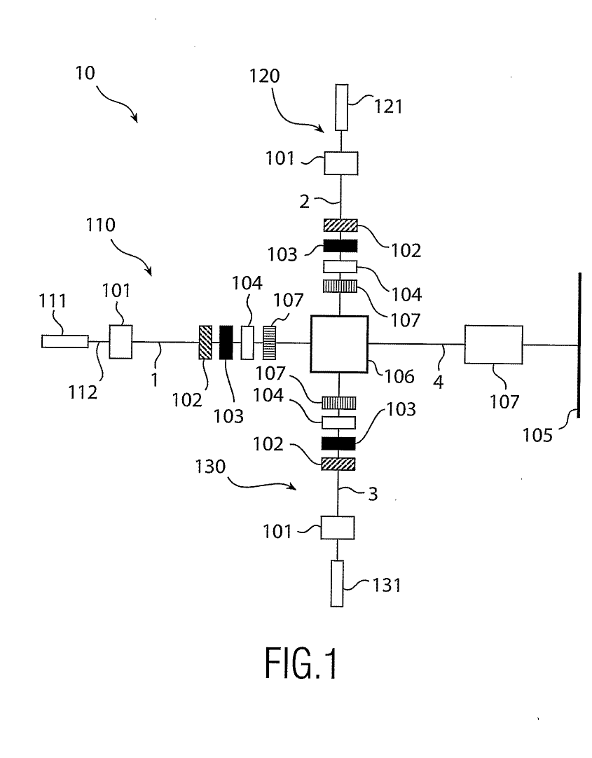

FIG. 1 is a schematic view of an image projection system according to the invention. The projector 10 comprises a green color modulation channel 110, which in turn comprises a green laser 111, illumination optics 101 and a modulation panel 102, such as an LCD device. A green illumination beam 112 emitted from the green laser 111 reaches the illumination optics 101, which converts it into a collimated optical beam with a desired spot size. The collimated green illumination beam 112 traverses the optical system along an optical axis 1, until it reaches a transmissive LCD device 102, optically behind which an analyzer or polarizer 103 is arranged.

A transmissive LCD device 102 comprises an array of LCD elements, wherein each element can be switched into a bright or dark state, e.g. by the application or removal of an electrical field. The difference between the two states is that in the bright state the emitted light has a first direction of polarization, and in the dark state the emitted light has a second direction of polarization, different from said first direction. Preferably, said first and second polarization direction is orthogonal to each other.

The polarizer 103 is arranged such that when the LCD element is in its bright state, light emitted from the LCD element is able to pass the polarizer. Further, the polarizer is arranged such that, when the LCD element is in its dark state, the emitted light will be blocked by the polarizer. An image can be generated by arranging some of the LCD elements in one of the two states, and the rest in the other, and illuminating the LCD array. The light transmitted by the polarizer will then carry the image information, i.e. the illumination beam is modulated with image information and can be viewed, if the modulated illumination beam is projected e.g. on a screen 105.

The projector 10 comprises three color modulation channels in total, i.e. besides the green channel 110 also a red color modulation channel 120 and a blue color modulation channel 130. The red and the blue channels 120,130, respectively, are arranged as described in relation to the green channel 110, except for the fact that the laser 121 in the red color modulation channel 120 emits red illumination beam along a second optical axis 2, and the laser 131 in the blue color modulation channel 130 emits a blue illumination beam along a third optical axis 3. The three optical axes 1,2,3 are arranged such that they are directed towards a common intersection point. The second and third axis 2,3 are in-line and directed towards each other, whereas said first axis 1 is orthogonal to the two others 2,3.

A color combination element 106, such as an X-cube or dichroic prism, is arranged in the intersection point of the optical axes 1,2,3 such that each modulated illumination beam 112,122,132 transmitted through the respective modulation plates 102, is combined into a multicolor modulated light beam along a single optical output axis 4. These are thereafter projected by projection optics 106, such as a projection lens, onto e.g. a screen 105.

In order to improve the quality of the projected image an etendue transforming element (ETE) 104 is placed downstream of the modulation panel 102 in the beam path from the light source to the projection optics. Preferably, an ETE 104 is placed after each modulation plate 102 and before the color combination element 106, in each color modulation channel. Alternatively, one ETE is placed optically behind the color combination element 106 and optically before the projection lens 106. This requires that an image of the display is projected on the diffuser.

In this description a diffuser is an element featuring multiple scattering of light, which passes through it. This scattering is substantially a mixture of refraction and reflection on structures which are larger than the wavelength of the light. The characteristics of the scattering depend on the structure of the transmitted light (random or ordered) and feature size of the diffuser. Preferably, the diffuser used in the projector scatters light into a well defined cone. Diffuser material with a well defined exit aperture and cone angles are commercially available for instance from the US-firm “Physical Optics Corporation”. These can be tailor made to fit the needs of a certain application.

In this description the term “etendue transforming element (ETE)” comprises all elements which are capable of broaden an incident beam, i.e. not only the diffusers previously described, but also elements based on diffraction such as diffraction gratings and holographic optical elements (HOEs). The feature size of these components is typically in the order of the wavelength of the light. HOEs can be generated by laser illumination of photosensitive films or even computer generated and produced by lithography and replication techniques. The distinction between scattering diffuser and HOEs is somewhat theoretical and practical devices is many times somewhere in between.

It is also possible to use micro-lens arrays, such as lens structures from the UK-firm Microsharp or diffusers consisting of small glass spheres in a polymer film, as ETEs.

Further the ETE 104 might be provided with a e.g. a switchable liquid crystal layer 107, such that the transmitted beam is switchable between a broadened and a not or less broadened state. Although the ETE 104 and the switchable liquid crystal layer 107 are illustrated as two separated devices, the LC-layer is preferably arranged on top of a rough surface of said ETE.

Preferably, the ETE is arranged such that it transforms a well-collimated beam of a first high f-number f#1 into a homogenous (or smoothly varying) divergent beam of a second low f-number f#2. Further, the diffuser should have a low in-line transmission, in order not to transmit the high f-number beam f# 1. In addition the diffuser should be non-Lambertian in the sense that as much as possible of the incident light should be collected in a forward beam of the given low f-number f#2, and not scattered outside this beam. Moreover, a significant percentage of the total energy should be scattered into the larger angles corresponding to the low f-number f#2. Ideal scattering characteristics would be a uniform far-field distribution. Sample surface structures are commercially available in angles from 0.5° to 80°, with elliptic or rectangular cones, spanning the low f-number f#2.

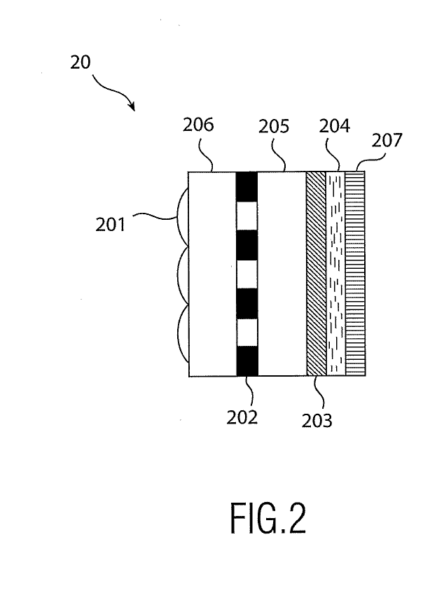

FIG. 2 is a schematic view of an embodiment of an optical component 20 comprising an LCD layer 202 and an etendue transforming layer or ETE 204. The arrangement can be used in the projector system 10 described relation to FIG. 1, whereby it replaces a described modulation panel 102, polarizer 103 and ETE arrangement 104. The LCD layer 202, which comprises LCD elements or pixels, is sandwiched between a first glass substrate 205 and a second glass substrate 206. An array of microlenses 201 are arranged on an opposite side of said second glass substrate 205, compared to said LCD layer 202. An analyzer layer 203 is arranged on an opposite side of said first glass substrate 206, compared to said LCD layer 202. Further the ETE 204 is arranged between the LCD layer and the analyzer layer 203, as the ETE most likely will depolarize the transmitted light.

Each microlens in the micro lens array 201 have approximately the same dimensions as a single pixel pitch of the LCD 202, and focuses incident light into the geometrical opening of the pixel. The high field of depth of the system is used to direct the incident light through the apertures in the LCD layer 202, such that the light does not hit obstructing structures, like electrodes and light shields. With a pixel pitch of about 5 μm and a glass thickness of about 500 μm, the laser based projector requires a factor 500 better collimation, compared to an UHP-lamped based projector. This can easily be achieved with a standard high quality laser.

A light beam traversing through the pixels passes the analyzer layer 203 and hits the ETE 204 at the opposite surface of the LCD cell. The dimensions of the pixels are taken such that all light incident on a first microlens element in the microlens array 201 traverse through the pixel aperture, and hits the ETE 204 in an area equal to or smaller than the pixel pitch. The ETE has only slightly diffusing properties as described above, which changes the low etendue light area in an image and emits a telecentric lightbeam with a low f-number, e.g. f#=4.0 towards the projection lens. Since the light beam between the LCD panel and the projections lens are telecentric no color shifts and inhomogeneity is caused by a beam combining element (not shown) arranged further down in the beam path.

The optical element can further be provided with a switchable liquid crystal layer 207, arranged down streams of the etendue transforming element in the light path from the light source to the screen. The switchable liquid crystal layer is arranged on top of the etendue transforming element. The liquid crystal layer can be switched between a first active state and a second passive state, by the application or removal of an electrical field. In the passive state of the switchable liquid crystal layer its refractive index is arranged such that that the light, which has been diffused or broadened by the etendue transforming layer, is allowed to pass straight through. In the active state of the switchable liquid crystal layer its refractive index is instead arranged such that that the light, which has been diffused or broadened by the etendue transforming layer, is collimated or made less divergent. By switching the liquid crystal layer between its active and passive state at a frequency of at least 70 Hz, the visibility of speckle in the projected image is reduced.

Conclusively, what has been described is a laser based image projection system for displaying images, which comprises an LCD device and projection optics. By introducing a diffuser between the LCD device and the reflective polarizer, the quality of the projected image is improved. Material imperfections in the optical beam path, which were previously visible in the projected image due to the large field-of-depth of the system, is reduced. This is due to the fact that since the light beams between the LCD panel and the projection lens has been changed to a beam with a broader aperture, the visibility of scratches, material defects and other obscurations (like dust) are drastically reduced. Further, since the light beam has a low etendue till the beam hits the diffuser, very small LCD panels can be used. Similarly, the dimension of the panel will be determined by the limitations where a high contrast liquid crystal optical effect is still possible to obtain, e.g. with 5 μm pixels and 2 μm call gap. Smaller LCD panels enable lower f-numbers between the diffuser and the projection lens at the same level of system complexity, thereby enabling the use of smaller optical components after the LCD's (smaller color combining device and smaller projection lens), and simultaneously reducing the need for preventing surface defects, particle inclusions and dust in the image path.

In this document the word “comprising” does not exclude other elements or steps, the word “a” or “an” does not exclude a plurality, and a single component may fulfill the functions of several means recited in the claims.

1. An image projection system comprising:
a laser light source (111;121;131) for providing an illumination beam (112;122;132);
a modulation panel (102) for modulating the illumination beam with image information,
projection optics (106) for projecting the modulated illumination beam on a screen, and
etendue transforming means (104) for broadening said modulated illumination beam, said etendue transforming means being arranged after said modulation panel in the light path from the light source to the screen.

2. An image projection system according to claim 1, wherein said etendue transforming means (104) is arranged before said projection optics (106) in the light path from the light source (111) to the screen.

3. An image projection system according to claim 2, wherein said etendue transforming means (104) is a beam shaper device arranged such that the etendue transformed illumination beam has a substantially uniform angular distribution, and preferably a round or rectangular cross-sectional beam shape angular distribution.

4. An image projection system according to claim 3, wherein said etendue transforming means (104) is a diffuser, preferably a holographic diffuser.

5. An image projection system according to claim 1, wherein a said etendue transforming device (104) is arranged to be modulated at least at 70 Hz, in order to reduce the visibility of speckle in the projected image.

6. An image projection system according to claim 4, wherein said diffuser is provided with a switchable liquid crystal layer (107), arranged such that the illumination beam transmitted through said diffuser and said switchable liquid crystal layer can be switched between a broadened and a less broadened state, for reducing the visibility of speckle in the projected image.

7. An image projection system according to claim 1, wherein said modulation panel (102) is an LCD device.

8. An optical element, for use in a image projection system as defined in claim 1, comprising a first substrate (205) provided with a light modulating layer (202) and an etendue transforming layer (204), wherein said layers are preferably arranged on opposite sides of said substrate.

9. An optical element according to claim 8, wherein said substrate is further provided with a polarizing layer (203), which is preferably arranged between said light modulating layer (202) and said etendue transforming layer (204).

10. An optical element according to claim 9, wherein said first substrate (205) is further provided with a switchable liquid crystal layer (207) arranged between said etendue transforming layer (203) and said polarizing layer (204), for reducing the visibility of speckle in the projected image.

11. An optical element according to claim 10, further comprising a second substrate (206) and an array of lenses (201), wherein said modulation layer is arranged between said first substrate (205) and said second substrate (206), further said second substrate (206) is arranged between said array of lenses (201) and said modulation layer (202).

12. A method of image projection comprising the sequential steps of:
emitting an illumination beam of laser light;
modulating the illumination beam with image information;
etendue transforming said modulated illumination beam, such that its beam diameter is broadened; and
projecting said etendue transformed illumination beam on a screen.

13. A method according to claim 12, wherein said etendue transformation provides said illumination beam with a uniform angular distribution.

14. A method according to claim 13, which further comprises the step of switching said etendue transformed illumination beam between a broadened and a non-broadened state, before it is projected on a screen, said switching preferably being performed at a rate of at least 70 Hz such that the visibility of speckle in the projected image is reduced.
